(19) United States
(12) Patent Application Publication
(10) Pub. No.: US 2026/0005606 A1
(43) Pub. Date: Jan. 1, 2026

(54) SWITCHED-CAPACITOR VOLTAGE CONVERTER, CHIP, AND ELECTRONIC DEVICE

(71) Applicant: Zhuhai Nanxin Semiconductor Technology Co., Ltd., Zhuhai City (CN)

(72) Inventor: Wei Zhao, Zhuhai City (CN)

(21) Appl. No.: 19/250,423

(22) Filed: Jun. 26, 2025

(30) Foreign Application Priority Data
Jun. 28, 2024 (CN) 202410866320.9

(51) Int. Cl. H02M 3/07; H02M 1/00; H02M 3/158

(52) U.S. Cl. CPC H02M 3/07; H02M 1/0058; H02M 3/158

(57) ABSTRACT

The present disclosure provides a switched-capacitor voltage converter, a chip, and an electronic device. In the switched-capacitor voltage converter, a first branch, a second branch, a third branch, and a fourth branch are electrically connected between an input terminal and a ground terminal of the switched-capacitor voltage converter, and are further electrically connected to an output terminal of the switched-capacitor voltage converter. Transistors in the first branch and the second branch are configured to be simultaneously turned on or turned off and of different sizes, and transistors in the third branch and the fourth branch are configured to be simultaneously turned on or turned off and of different sizes. When the output terminal of the switched-capacitor voltage converter is electrically connected to a small load, the transistors in the branches may be controlled to be turned off, such that loss of the switched-capacitor voltage converter is effectively reduced.

### CROSS-REFERENCE TO RELATED APPLICATION

This application is based upon and claims the priority of Chinese Patent Application No. 202410866320.9, filed on Jun. 28, 2024, the entire content of which is hereby incorporated by reference herein and made a part of this specification.

### TECHNICAL FIELD

The present disclosure relates to the technical field of electronics, and in particular, relates to a switched-capacitor voltage converter, a chip, and an electronic device.

### BACKGROUND

A switched-capacitor voltage converter is configured to convert an input voltage into an output voltage that has the same or a different magnitude from the input voltage. For example, in a case where the switched-capacitor voltage converter is a 2:1 switched-capacitor voltage converter, it is used to reduce an input high voltage to a low voltage that is half the input voltage to supply power to a load.

Currently, the loss of a switched-capacitor voltage converter mainly includes: (1) conduction loss, which is related to the current and impedance in the path; (2) capacitive loss, which is related to the capacitance across the drain-source terminals of the transistors, voltage, and switching frequency; and (3) drive loss, which is related to the gate capacitance of the transistors, voltage, the power supply structure of the drive circuit, and the switching frequency.

However, in a case where the load electrically connected to the output terminal is small (or has a small load capacity), the proportion of capacitive loss and drive loss in the total losses increases. Typically, the capacitive loss and drive loss of the switched-capacitor voltage converter are reduced by constantly reducing the switching frequency of the transistors in the switched-capacitor voltage converter, such that the conversion efficiency of the switched-capacitor voltage converter is improved. However, where the switching frequency of the transistors is low, for example, below 40 kHz, the switching frequency may be easily perceived by human ears, thereby generating audible noise. Conversely, where the switching frequency of the transistors in the switched-capacitor voltage converter is high, the efficiency of the switched-capacitor voltage converter may decrease.

### SUMMARY

In view of the above technical problem, some embodiments of the present disclosure provide a switched-capacitor voltage converter, which effectively improves the conversion efficiency of the switched-capacitor voltage converter while reducing the frequency.

In a first aspect, the embodiments of the present disclosure provide a switched-capacitor voltage converter. The switched-capacitor voltage converter includes:
a first branch, a second branch, a third branch, a fourth branch, a first charge-discharge circuit, a second charge-discharge circuit, and a transistor control circuit; wherein
the first branch, the second branch, the third branch, and the fourth branch are all electrically connected between an input terminal and a ground terminal of the switched-capacitor voltage converter, and the first branch, the second branch, the third branch, and the fourth branch are all further electrically connected to an output terminal of the switched-capacitor voltage converter;
each of the first branch, the second branch, the third branch, and the fourth branch includes a plurality of transistors, wherein transistors in the first branch and transistors in the second branch are configured to be simultaneously turned on or turned off and are of different sizes, transistors in the third branch and transistors in the fourth branch are configured to be simultaneously turned on or turned off and are of different sizes, the transistor control circuit is electrically connected to drive terminals of all the transistors in each of the first branch, the second branch, the third branch, and the fourth branch;
a first terminal of the first charge-discharge circuit is electrically connected to both the first branch and the second branch and is close to the input terminal of the switched-capacitor voltage converter, a second terminal of the first charge-discharge circuit is electrically connected to both the first branch and the second branch and is close to the ground terminal of the switched-capacitor voltage converter; and
a first terminal of the second charge-discharge circuit is electrically connected to both the third branch and the fourth branch and is close to the input terminal of the switched-capacitor voltage converter, a second terminal of the second charge-discharge circuit is electrically connected to both the third branch and the fourth branch and is close to the ground terminal of the switched-capacitor voltage converter.

In the switched-capacitor voltage converter according to the first aspect, during voltage conversion, the transistors in the first branch and the transistors in the second branch are configured to be simultaneously turned on or turned off and are of different sizes, the transistors in the third branch and the transistors in the fourth branch are configured to be simultaneously turned on or turned off and are of different sizes. Therefore, a state of each of the branches may be determined based on a load capacity of a load electrically connected to the output terminal of the switched-capacitor voltage converter. In a case where the load capacity of the load electrically connected to the output terminal is small, the transistors in the branches may be controlled to be turned off based on the transistor control circuit such that the drive loss is effectively reduced, and hence the conversion efficiency of the switched-capacitor voltage converter is effectively improved.

In some embodiments, the switched-capacitor voltage converter further includes an inductive charge transfer circuit; wherein a first terminal of the inductive charge transfer circuit is electrically connected to the second terminal of the first charge-discharge circuit, a second terminal of the inductive charge transfer circuit is electrically connected to the second terminal of the second charge-discharge circuit, and a drive terminal of the inductive charge transfer circuit is electrically connected to the transistor control circuit.

In some embodiments, the transistor control circuit is configured to control the inductive charge transfer circuit to be turned on in a case where the first branch, the second branch, the third branch, and the fourth branch are all in an OFF state; and the transistor control circuit is further configured to: in a case where a load capacity of a load is less than a predetermined threshold and control the first branch and the fourth branch to be constantly in the OFF state, then control the second branch to be in a first ON state and the third branch to be in a second ON state and subsequently control the second branch and the third branch to be in the OFF state, and control the second branch to be in the second ON state and the third branch to be in the first ON state.

In some embodiments, the transistor control circuit is further configured to: in a case where a load capacity of a load is greater than or equal to a predetermined threshold, control the first branch and the second branch to be in a first ON state and the third branch and the fourth branch to be in a second ON state, then control the first branch, the second branch, the third branch, and the fourth branch to be in the OFF state, and subsequently control the first branch and the second branch to be in the second ON state and the third branch and the fourth branch to be in the first ON state.

In some embodiments, the first branch includes a first transistor, a second transistor, a third transistor, and a fourth transistor, wherein a first terminal of the first transistor is electrically connected to the input terminal of the switched-capacitor voltage converter, a drive terminal of the first transistor is electrically connected to the transistor control circuit, a second terminal of the first transistor is electrically connected to a first terminal of the second transistor, a drive terminal of the second transistor is electrically connected to the transistor control circuit, a second terminal of the second transistor is electrically connected to a first terminal of the third transistor, a drive terminal of the third transistor is electrically connected to the transistor control circuit, a second terminal of the third transistor is electrically connected to a first terminal of the fourth transistor, a drive terminal of the fourth transistor is electrically connected to the transistor control circuit, and a second terminal of the fourth transistor is electrically connected to the ground terminal of the switched-capacitor voltage converter.

The second branch includes a fifth transistor, a sixth transistor, a seventh transistor, and an eighth transistor, wherein a first terminal of the fifth transistor is electrically connected to the input terminal of the switched-capacitor voltage converter, a drive terminal of the fifth transistor is electrically connected to the transistor control circuit, a second terminal of the fifth transistor is electrically connected to a first terminal of the sixth transistor, a drive terminal of the sixth transistor is electrically connected to the transistor control circuit, a second terminal of the sixth transistor is electrically connected to a first terminal of the seventh transistor, a drive terminal of the seventh transistor is electrically connected to the transistor control circuit, a second terminal of the seventh transistor is electrically connected to a first terminal of the eighth transistor, a drive terminal of the eighth transistor is electrically connected to the transistor control circuit, and a second terminal of the eighth transistor is electrically connected to the ground terminal of the switched-capacitor voltage converter.

The third branch includes a ninth transistor, a tenth transistor, an eleventh transistor, and a twelfth transistor, wherein a first terminal of the ninth transistor is electrically connected to the input terminal of the switched-capacitor voltage converter, a drive terminal of the ninth transistor is electrically connected to the transistor control circuit, a second terminal of the ninth transistor is electrically connected to a first terminal of the tenth transistor, a drive terminal of the tenth transistor is electrically connected to the transistor control circuit, a second terminal of the tenth transistor is electrically connected to a first terminal of the eleventh transistor, a drive terminal of the eleventh transistor is electrically connected to the transistor control circuit, a second terminal of the eleventh transistor is electrically connected to a first terminal of the twelfth transistor, a drive terminal of the twelfth transistor is electrically connected to the transistor control circuit, and a second terminal of the twelfth transistor is electrically connected to the ground terminal of the switched-capacitor voltage converter.

The fourth branch includes a thirteenth transistor, a fourteenth transistor, a fifteenth transistor, and a sixteenth transistor, wherein a first terminal of the thirteenth transistor is electrically connected to the input terminal of the switched-capacitor voltage converter, a drive terminal of the thirteenth transistor is electrically connected to the transistor control circuit, a second terminal of the thirteenth transistor is electrically connected to a first terminal of the fourteenth transistor, a drive terminal of the fourteenth transistor is electrically connected to the transistor control circuit, a second terminal of the fourteenth transistor is electrically connected to a first terminal of the fifteenth transistor, a drive terminal of the fifteenth transistor is electrically connected to the transistor control circuit, a second terminal of the fifteenth transistor is electrically connected to a first terminal of the sixteenth transistor, a drive terminal of the sixteenth transistor is electrically connected to the transistor control circuit, and a second terminal of the sixteenth transistor is electrically connected to the ground terminal of the switched-capacitor voltage converter.

The first terminal of the first charge-discharge circuit is electrically connected between the second terminal of the first transistor and the first terminal of the second transistor and between the second terminal of the fifth transistor and the first terminal of the sixth transistor, and the second terminal of the first charge-discharge circuit is electrically connected between the second terminal of the third transistor and the first terminal of the fourth transistor and between the second terminal of the seventh transistor and the first terminal of the eighth transistor.

The first terminal of the second charge-discharge circuit is electrically connected between the second terminal of the ninth transistor and the first terminal of the tenth transistor and between the second terminal of the thirteenth transistor and the first terminal of the fourteenth transistor, and the second terminal of the second charge-discharge circuit is electrically connected between the second terminal of the eleventh transistor and the first terminal of the twelfth transistor and between the second terminal of the fifteenth transistor and the first terminal of the sixteenth transistor.

In some embodiments, a size of each of the transistors in the first branch is at least twice a size of each of the transistors in the second branch; and a size of each of the transistors in the fourth branch is at least twice a size of each of the transistors in the third branch.

In some embodiments, in a case where the first branch is in a first ON state, the first transistor and the third transistor are in an ON state, and the second transistor and the fourth transistor are in an OFF state; or in a case where the first branch is in a second ON state, the first transistor and the third transistor are in an OFF state, and the second transistor and the fourth transistor are in an ON state.

In a case where the second branch is in a first ON state, the fifth transistor and the seventh transistor are in an ON state, and the sixth transistor and the eighth transistor are in an OFF state; or in a case where the second branch is in a second ON state, the fifth transistor and the seventh transistor are in an OFF state, and the sixth transistor and the eighth transistor are in an ON state.

In a case where the third branch is in a first ON state, the ninth transistor and the eleventh transistor are in an ON state, and the tenth transistor and the twelfth transistor are in an OFF state; or in a case where the third branch is in a second ON state, the ninth transistor and the eleventh transistor are in an OFF state, and the tenth transistor and the twelfth transistor are in an ON state.

In a case where the fourth branch is in a first ON state, the thirteenth transistor and the fifteenth transistor are in an ON state, and the fourteenth transistor and the sixteenth transistor are in an OFF state; or in a case where the fourth branch is in a second ON state, the thirteenth transistor and the fifteenth transistor are in an OFF state, and the fourteenth transistor and the sixteenth transistor are in an ON state.

In some embodiments, the inductive charge transfer circuit includes a seventeenth transistor, an eighteenth transistor, and an inductor; wherein a first terminal of the seventeenth transistor is electrically connected to the second terminal of the first charge-discharge circuit, a second terminal of the seventeenth transistor is electrically connected to a first terminal of the inductor, a second terminal of the inductor is electrically connected to a second terminal of the eighteenth transistor, and a first terminal of the eighteenth transistor is electrically connected to the second terminal of the second charge-discharge circuit.

In some embodiments, the switched-capacitor voltage converter further includes a logic circuit, configured to control on or off of the transistors in the first branch and the fourth branch under control of the transistor control circuit.

In some embodiments, the logic circuit is integrated in the transistor control circuit.

In a second aspect, the embodiments of the present disclosure provide a chip. The chip includes the switched-capacitor voltage converter as described above.

In a third aspect, the embodiments of the present disclosure provide an electronic device. The electronic device includes the chip as described above.

### BRIEF DESCRIPTION OF THE DRAWINGS

FIG. 1 is a circuit diagram of a dual 2:1 switched-capacitor voltage converter according to some embodiments of the present disclosure;

FIG. 2 is a circuit diagram of a switched-capacitor voltage converter according to some embodiments of the present disclosure;

FIG. 3 is a diagram illustrating pulse waveforms of components and nodes in a case where a switched-capacitor voltage converter is electrically connected to a load with a load capacity being less than a predetermined threshold and runs according to some embodiments of the present disclosure; and

FIG. 4 is a diagram illustrating pulse waveforms of components and nodes in a case where a switched-capacitor voltage converter is electrically connected to a load with a load capacity greater than or equal to a predetermined threshold and runs according to some embodiments of the present disclosure.

### DETAILED DESCRIPTION

In the present disclosure, the term “at least one” refers to one or more than one, and the term “a plurality of” refers to two or more than two. The term “and/or” is merely an association relationship for describing associated objects, which represents that there may exist three types of relationships. For example, the phrase “A and/or B” means (A), (B), or (A and B), wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is turned on, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

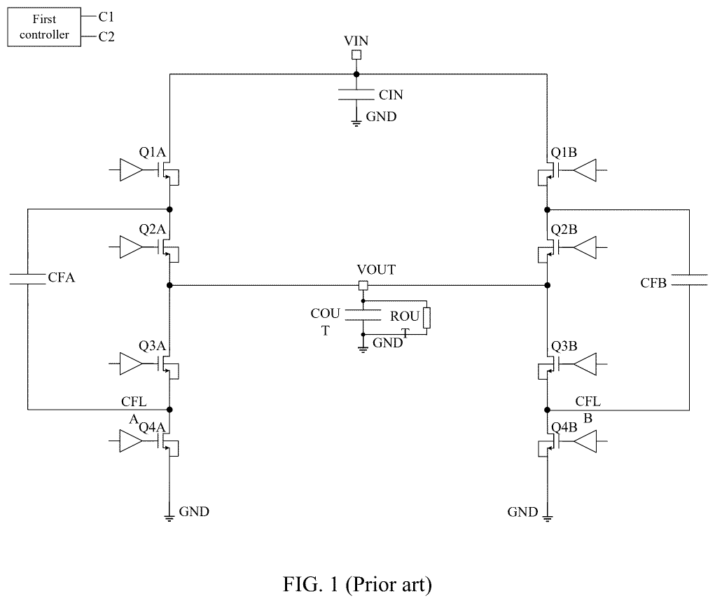

For various types of switched-capacitor voltage converters, the output terminal of the converter may supply an output voltage to a load. In this scenario, the load capacity of the load may be constant, or may vary within a range. However, the switched-capacitor voltage converter is required to continuously maintain a high conversion efficiency. In a case where the load capacity of the load electrically connected to the output terminal of the switched-capacitor voltage converter is small, the capacitive loss and drive loss of the switched-capacitor voltage converter are large, which consequently causes the conversion efficiency of the switched-capacitor voltage converter to decrease. This problem may be explained in detail using the switched-capacitor voltage converter illustrated in FIG. 1 as an example.

FIG. 1 is a circuit diagram of a dual 2:1 switched-capacitor voltage converter according to some embodiments of the present disclosure. In the dual 2:1 switched-capacitor voltage converter as illustrated in FIG. 1, a voltage at a first output terminal VOUT of the switched-capacitor voltage converter is half a voltage at a first input terminal VIN of the switched-capacitor voltage converter.

The switched-capacitor voltage converter as illustrated in FIG. 1 includes a first controller, a nineteenth transistor Q1A, a twentieth transistor Q2A, a twenty-first transistor Q3A, a twenty-second transistor Q4A, a twenty-third transistor Q1B, a twenty-fourth transistor Q2B, a twenty-fifth transistor Q3B, a twenty-sixth transistor Q4B, a first input terminal VIN, a first output terminal VOUT, a fifth capacitor CFA, a sixth capacitor CFB, a seventh capacitor CIN, and an eighth capacitor COUT.

The first controller includes a first output port C1 and a second output port C2. The first output port C1 of the first controller outputs a first control signal. The first control signal is used to control on or off of the nineteenth transistor Q1A, the twenty-first transistor Q3A, the twenty-fourth transistor Q2B, and the twenty-sixth transistor Q4B. The second output port C2 of the first controller outputs a second control signal. The second control signal is used to control on or off of the twentieth transistor Q2A, the twenty-second transistor Q4A, the twenty-third transistor Q1B, and the twenty-fifth transistor Q3B.

In a case where the switched-capacitor voltage converter is in a first phase, the nineteenth transistor Q1A, the twenty-first transistor Q3A, the twenty-fourth transistor Q2B, and the twenty-sixth transistor Q4B are turned on, and the twentieth transistor Q2A, the twenty-second transistor Q4A, the twenty-third transistor Q1B, and the twenty-fifth transistor Q3B are turned off.

In a case where the switched-capacitor voltage converter is in a second phase, the twentieth transistor Q2A, the twenty-second transistor Q4A, the twenty-third transistor Q1B, and the twenty-fifth transistor Q3B are turned on, and the nineteenth transistor Q1A, the twenty-first transistor Q3A, the twenty-fourth transistor Q2B, and the twenty-sixth transistor Q4B are turned off.

In the switched-capacitor voltage converter, the nineteenth transistor Q1A, the twentieth transistor Q2A, the twenty-first transistor Q3A, the twenty-second transistor Q4A, the twenty-third transistor Q1B, the twenty-fourth transistor Q2B, the twenty-fifth transistor Q3B, and the twenty-sixth transistor Q4B need to be electrically connected to a load with a large load capacity, and thus these transistors have a large size. In a case where the first output terminal VOUT of the switched-capacitor voltage converter is electrically connected to a load with a small load capacity, since the nineteenth transistor Q1A, the twentieth transistor Q2A, the twenty-first transistor Q3A, the twenty-second transistor Q4A, the twenty-third transistor Q1B, the twenty-fourth transistor Q2B, the twenty-fifth transistor Q3B, and the twenty-sixth transistor Q4B all have a large size, large drive loss and large capacitive loss are caused during running of these transistors. Consequently, the switched-capacitor voltage converter has a low conversion efficiency.

In view of the above problem, some embodiments of the present disclosure provide a switched-capacitor voltage converter, a chip, and an electronic device. The switched-capacitor voltage converter may include a plurality of branches, and in a case where loads with different load capacities are electrically connected to the output terminal of the switched-capacitor voltage converter, some transistors in the branches corresponding to the loads with different load capacities in the switched-capacitor voltage converter are turned on. That is, the switched-capacitor voltage converter is capable of dynamically adjusting the state of the corresponding branch in response to changes in the load capacity of the load connected thereto, such that the switched-capacitor voltage converter is enabled to continuously output the voltage to the load with high efficiency.

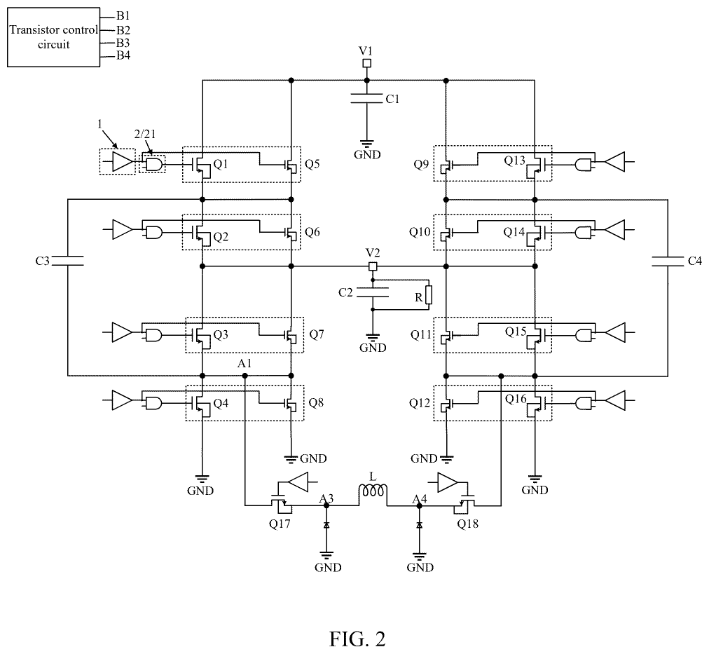

FIG. 2 is a circuit diagram of a switched-capacitor voltage converter according to some embodiments of the present disclosure. As illustrated in FIG. 2, the switched-capacitor voltage converter may include a first branch, a second branch, a third branch, a fourth branch, a first charge-discharge circuit, a second charge-discharge circuit, and a transistor control circuit.

The first branch, the second branch, the third branch, and the fourth branch are all electrically connected between an input terminal V1 and a ground terminal GND of the switched-capacitor voltage converter, and the first branch, the second branch, the third branch, and the fourth branch are all further electrically connected to an output terminal V2 of the switched-capacitor voltage converter.

Each of the first branch, the second branch, the third branch, and the fourth branch includes a plurality of transistors, wherein transistors in the first branch and transistors in the second branch are configured to be simultaneously turned on or turned off and are of different sizes, transistors in the third branch and transistors in the fourth branch are configured to be simultaneously turned on or turned off and are of different sizes, the transistor control circuit is electrically connected to drive terminals of all the transistors in each of the first branch, the second branch, the third branch, and the fourth branch.

A first terminal of the first charge-discharge circuit is electrically connected to both the first branch and the second branch and is close to the input terminal V1 of the switched-capacitor voltage converter, a second terminal of the first charge-discharge circuit is electrically connected to both the first branch and the second branch and is close to the ground terminal GND of the switched-capacitor voltage converter.

A first terminal of the second charge-discharge circuit is electrically connected to both the third branch and the fourth branch and is close to the input terminal V1 of the switched-capacitor voltage converter, a second terminal of the second charge-discharge circuit is electrically connected to both the third branch and the fourth branch and is close to the ground terminal GND of the switched-capacitor voltage converter.

The switched-capacitor voltage converter as illustrated in FIG. 2 may further include an inductive charge transfer circuit.

As illustrated in FIG. 2, a first terminal of the inductive charge transfer circuit is electrically connected to the second terminal of the first charge-discharge circuit, a second terminal of the inductive charge transfer circuit is electrically connected to the second terminal of the second charge-discharge circuit, and a drive terminal of the inductive charge transfer circuit is electrically connected to the transistor control circuit.

As illustrated in FIG. 2, the first branch includes a first transistor Q1, a second transistor Q2, a third transistor Q3, and a fourth transistor Q4, wherein a first terminal of the first transistor Q1 is electrically connected to the input terminal V1 of the switched-capacitor voltage converter, a drive terminal of the first transistor Q1 is electrically connected to the transistor control circuit, a second terminal of the first transistor Q1 is electrically connected to a first terminal of the second transistor Q2, a drive terminal of the second transistor Q2 is electrically connected to the transistor control circuit, a second terminal of the second transistor Q2 is electrically connected to a first terminal of the third transistor Q3, a drive terminal of the third transistor Q3 is electrically connected to the transistor control circuit, a second terminal of the third transistor Q3 is electrically connected to a first terminal of the fourth transistor Q4, a drive terminal of the fourth transistor Q4 is electrically connected to the transistor control circuit, and a second terminal of the fourth transistor Q4 is electrically connected to the ground terminal GND of the switched-capacitor voltage converter.

The second branch includes a fifth transistor Q5, a sixth transistor Q6, a seventh transistor Q7, and an eighth transistor Q8, wherein a first terminal of the fifth transistor Q5 is electrically connected to the input terminal V1 of the switched-capacitor voltage converter, a drive terminal of the fifth transistor Q5 is electrically connected to the transistor control circuit, a second terminal of the fifth transistor Q5 is electrically connected to a first terminal of the sixth transistor Q6, a drive terminal of the sixth transistor Q6 is electrically connected to the transistor control circuit, a second terminal of the sixth transistor Q6 is electrically connected to a first terminal of the seventh transistor Q7, a drive terminal of the seventh transistor Q7 is electrically connected to the transistor control circuit, a second terminal of the seventh transistor Q7 is electrically connected to a first terminal of the eighth transistor Q8, a drive terminal of the eighth transistor Q8 is electrically connected to the transistor control circuit, and a second terminal of the eighth transistor Q8 is electrically connected to the ground terminal GND of the switched-capacitor voltage converter.

The third branch includes a ninth transistor Q9, a tenth transistor Q10, an eleventh transistor Q11, and a twelfth transistor Q12, wherein a first terminal of the ninth transistor Q9 is electrically connected to the input terminal V1 of the switched-capacitor voltage converter, a drive terminal of the ninth transistor Q9 is electrically connected to the transistor control circuit, a second terminal of the ninth transistor Q9 is electrically connected to a first terminal of the tenth transistor Q10, a drive terminal of the tenth transistor Q10 is electrically connected to the transistor control circuit, a second terminal of the tenth transistor Q10 is electrically connected to a first terminal of the eleventh transistor Q11, a drive terminal of the eleventh transistor Q11 is electrically connected to the transistor control circuit, a second terminal of the eleventh transistor Q11 is electrically connected to a first terminal of the twelfth transistor Q12, a drive terminal of the twelfth transistor Q12 is electrically connected to the transistor control circuit, and a second terminal of the twelfth transistor Q12 is electrically connected to the ground terminal GND of the switched-capacitor voltage converter.

The fourth branch includes a thirteenth transistor Q13, a fourteenth transistor Q14, a fifteenth transistor Q15, and a sixteenth transistor Q16, wherein a first terminal of the thirteenth transistor Q13 is electrically connected to the input terminal V1 of the switched-capacitor voltage converter, a drive terminal of the thirteenth transistor Q13 is electrically connected to the transistor control circuit, a second terminal of the thirteenth transistor Q13 is electrically connected to a first terminal of the fourteenth transistor Q14, a drive terminal of the fourteenth transistor Q14 is electrically connected to the transistor control circuit, a second terminal of the fourteenth transistor Q14 is electrically connected to a first terminal of the fifteenth transistor Q15, a drive terminal of the fifteenth transistor Q15 is electrically connected to the transistor control circuit, a second terminal of the fifteenth transistor Q15 is electrically connected to a first terminal of the sixteenth transistor Q16, a drive terminal of the sixteenth transistor Q16 is electrically connected to the transistor control circuit, and a second terminal of the sixteenth transistor Q16 is electrically connected to the ground terminal GND of the switched-capacitor voltage converter.

The first terminal of the first charge-discharge circuit is electrically connected between the second terminal of the first transistor Q1 and the first terminal of the second transistor Q2 and between the second terminal of the fifth transistor Q5 and the first terminal of the sixth transistor Q6, and the second terminal of the first charge-discharge circuit is electrically connected between the second terminal of the third transistor Q3 and the first terminal of the fourth transistor Q4 and between the second terminal of the seventh transistor Q7 and the first terminal of the eighth transistor Q8.

The first terminal of the second charge-discharge circuit is electrically connected between the second terminal of the ninth transistor Q9 and the first terminal of the tenth transistor Q10 and between the second terminal of the thirteenth transistor Q13 and the first terminal of the fourteenth transistor Q14, and the second terminal of the second charge-discharge circuit is electrically connected between the second terminal of the eleventh transistor Q11 and the first terminal of the twelfth transistor Q12 and between the second terminal of the fifteenth transistor Q15 and the first terminal of the sixteenth transistor Q16.

Referring to FIG. 2, the transistor control circuit is configured to control the inductive charge transfer circuit to be turned on in a case where the first branch, the second branch, the third branch, and the fourth branch are all in an OFF state.

The transistor control circuit is further configured to: in a case where a load capacity of a load is less than a predetermined threshold, control the first branch and the fourth branch to be constantly in the OFF state and control the second branch to be in a first ON state and the third branch to be in a second ON state, then control the second branch and the third branch to be in the OFF state and subsequently control the second branch to be in the second ON state and the third branch to be in the first ON state.

In the switched-capacitor voltage converter as illustrated in FIG. 2, the size of each of the transistors in the first branch is different from the size of each of the transistors in the second branch, the size of each of the transistors in the third branch is different from the size of each of the transistors in the fourth branch, and the transistor control circuit is configured to compare a detected input current and output current of the switched-capacitor voltage converter with an input threshold current and an output threshold current that are predefined in the switched-capacitor voltage converter respectively to determine whether a load capacity of a current load is less than a predetermined threshold. The predetermined threshold is determined based on an application scenario or application system of the switched-capacitor voltage converter. In a case where the load capacity of the current load is less than the predetermined threshold, the transistor control circuit controls the transistors in both the first branch and the fourth branch to be in the OFF state, such that the transistors in the second branch and the third branch are alternately turned on. In addition, since the sizes of the transistors in the second branch and the third branch are smaller, the drive loss of the switched-capacitor voltage converter is effectively reduced. Furthermore, the inductive charge transfer circuit is arranged in the switched-capacitor voltage converter, such that the transistors in the second branch and the third branch are turned on under zero voltage, and hence the conversion efficiency of the switched-capacitor voltage converter is further improved.

In the switched-capacitor voltage converter as illustrated in FIG. 2, the first branch may be in the OFF state, the first ON state, or the second ON state. In a case where the first branch is in the OFF state, the first transistor Q1, the second transistor Q2, the third transistor Q3, and the fourth transistor Q4 in the first branch are all turned off. The states of the first transistor Q1, the second transistor Q2, the third transistor Q3, and the fourth transistor Q4 in a case where the first branch is in the first ON state are opposite to the states of the first transistor Q1, the second transistor Q2, the third transistor Q3, and the fourth transistor Q4 in a case where the first branch is in the second ON state, wherein the state refers to an ON state or OFF state of the transistors.

In the switched-capacitor voltage converter as illustrated in FIG. 2, the second branch may be in the OFF state, the first ON state, or the second ON state. In a case where the second branch is in the OFF state, the fifth transistor Q5, the sixth transistor Q6, the seventh transistor Q7, and the eighth transistor Q8 in the second branch are all turned off. The states of the fifth transistor Q5, the sixth transistor Q6, the seventh transistor Q7, and the eighth transistor Q8 in a case where the second branch is in the first ON state are opposite to the states of the fifth transistor Q5, the sixth transistor Q6, the seventh transistor Q7, and the eighth transistor Q8 in a case where the second branch is in the second ON state, wherein the state refers to the ON state or OFF state of a transistor.

Further, that the transistors in the first branch and the transistors in the second branch are configured to be simultaneously turned on or turned off means that in a case where the load capacity of the load is greater than or equal to the predetermined threshold, the first transistor Q1 and the fifth transistor Q5 are simultaneously turned on or turned off, the second transistor Q2 and the sixth transistor Q6 are simultaneously turned on or turned off, the third transistor Q3 and the seventh transistor Q7 are simultaneously turned on or turned off, and the fourth transistor Q4 and the eighth transistor Q8 are simultaneously turned on or turned off.

In the switched-capacitor voltage converter as illustrated in FIG. 2, the third branch may be in the OFF state, the first ON state, or the second ON state. In a case where the third branch is in the OFF state, the ninth transistor Q9, the tenth transistor Q10, the eleventh transistor Q11, and the twelfth transistor Q12 are all turned off. The states of the ninth transistor Q9, the tenth transistor Q10, the eleventh transistor Q11, and the twelfth transistor Q12 in a case where the third branch is in the first ON state are opposite to the states of the ninth transistor Q9, the tenth transistor Q10, the eleventh transistor Q11, and the twelfth transistor Q12 in a case where the third branch is in the second ON state, wherein the state refers to the ON state or OFF state of a transistor.

In the switched-capacitor voltage converter as illustrated in FIG. 2, the fourth branch may be in the OFF state, the first ON state, or the second ON state. In a case where the fourth branch is in the OFF state, the thirteenth transistor Q13, the fourteenth transistor Q14, the fifteenth transistor Q15, and the sixteenth transistor Q16 in the fourth branch are all turned off. The states of the thirteenth transistor Q13, the fourteenth transistor Q14, the fifteenth transistor Q15, and the sixteenth transistor Q16 in a case where the fourth branch is in the first ON state are opposite to the states of the thirteenth transistor Q13, the fourteenth transistor Q14, the fifteenth transistor Q15, and the sixteenth transistor Q16 in a case where the fourth branch is in the second ON state, wherein the state refers to the ON state or OFF state of a transistor.

Further, that the transistors in the third branch and the transistors in the fourth branch are configured to be simultaneously turned on or turned off means that in a case where the load capacity of the load is greater than or equal to the predetermined threshold, the ninth transistor Q9 and the thirteenth transistor Q13 are simultaneously turned on or turned off, the tenth transistor Q10 and the fourteenth transistor Q14 are simultaneously turned on or turned off, the eleventh transistor Q11 and the fifteenth transistor Q15 are simultaneously turned on or turned off, and the twelfth transistor Q12 and the sixteenth transistor Q16 are simultaneously turned on or turned off.

In addition, the transistors which may be simultaneously turned on or turned off in the plurality of branches achieve the same function or effect. For example, the first transistor in the first branch and the fifth transistor in the second branch are both configured to input a current to the first charge-discharge circuit.

In addition, the switched-capacitor voltage converter may be divided into a first block and a second block, and during running of the switched-capacitor voltage converter, the first block and the second block are in opposite states.

Using the switched-capacitor voltage converter according to the present disclosure as an example, the first block includes the first branch, the second branch, and the first charge-discharge circuit; and the second block includes the third branch, the fourth branch, and the second charge-discharge circuit.

Further, the switched-capacitor voltage converter is controlled based on a clock signal with a fixed frequency. In a case where the clock signal is in a third phase, the first block is in a first state, and the second block is in a second state. During this phase, an input current at the input terminal of the switched-capacitor voltage converter supplies a current to the first charge-discharge circuit based on at least one of the first branch and the second branch. In this case, the first charge-discharge circuit is in a charging state, and the second charge-discharge circuit is in a discharging state. In a case where the clock signal in a fourth phase, the first block is in the second state, and the second block is in the first state. During this phase, an input current at the input terminal of the switched-capacitor voltage converter supplies a current to the second charge-discharge circuit based on at least one of the third branch and the fourth branch. In this case, the second charge-discharge circuit is in the charging state, and the first charge-discharge circuit is in the discharging state.

During running of the switched-capacitor voltage converter, the third phase and the fourth phase alternately come into effect, and further, the first block and the second block are alternately in the first state or the second state.

Further, description is given by an example where the output terminal of the switched-capacitor voltage converter according to the present disclosure is electrically connected to a load with a load capacity less than the predetermined threshold. In this case, considering the settings for reducing loss, the transistor control circuit controls the transistors in both the first branch and the fourth branch to be constantly in the off state. In a case where the clock signal is in the third phase, that is, the first block is in the first state and the second block is in the second state, the second branch in the first block is in the first ON state, and the third branch is in the second ON state. In this case, the transistors in the second branch that are electrically connected to the input terminal of the switched-capacitor voltage converter are all in the ON state, and the second branch is configured to supply a current to the first charge-discharge circuit, such that the first charge-discharge circuit is in the charging state; and the transistors in the third branch that are electrically connected to the input terminal of the switched-capacitor voltage converter are all in the OFF state, and the second charge-discharge circuit is in the discharging state to supply a current to the third branch.

In a case where the clock signal is in the fourth phase, that is, the first block is in the second state and the second block is in the first state, the second branch in the first block is in the second ON state, and the third branch is in the first ON state. In this case, the transistors in the second branch that are electrically connected to the input terminal of the switched-capacitor voltage converter are all in the OFF state, and the first charge-discharge circuit is in the discharging state to supply a current to the second branch; and the transistors in the third branch that are electrically connected to the input terminal of the switched-capacitor voltage converter are all on the ON state, and the third branch supplies a current to the second charge-discharge circuit electrically connected to the third branch, and the second charge-discharge circuit is in the charging state. During running of the switched-capacitor voltage converter, in addition to a stage where the first branch, the second branch, the third branch, and the fourth branch are all in the OFF state, the second branch and the third branch are alternately in the first ON state or the second ON state.

In the present disclosure, description is given by an example where the transistors in only two branches are configured to be simultaneously turned on or turned off. However, the number of transistors that are configured to be simultaneously turned on or turned off is not limited to the above-described.

As illustrated in FIG. 2, each of the drive terminals of the transistors in the first branch, the second branch, the third branch, and the fourth branch is electrically connected to the transistor control circuit via a transistor driver 1, the input terminal V1 of the switched-capacitor voltage converter is electrically connected to the ground terminal GND of the switched-capacitor voltage converter via a first capacitor C1, the output terminal V2 of the switched-capacitor voltage converter is electrically connected to the ground terminal GND of the switched-capacitor voltage converter via a second capacitor C2, and a first resistor R is connected in parallel between two terminals of the second capacitor C2.

The first charge-discharge circuit may include a third capacitor C3. A first terminal of the third capacitor C3 is electrically connected between the second terminal of the first transistor Q1 and the first terminal of the second transistor Q2 and between the second terminal of the fifth transistor Q5 and the first terminal of the sixth transistor Q6, and a second terminal of the third capacitor C3 is electrically connected between the second terminal of the third transistor Q3 and the first terminal of the fourth transistor Q4 and between the second terminal of the seventh transistor Q7 and the first terminal of the eighth transistor Q8. The first terminal of the third capacitor C3 is an input terminal, and the second terminal of the third capacitor C3 is an output terminal.

The second charge-discharge circuit may include a fourth capacitor C4. A first terminal of the fourth capacitor C4 is electrically connected between the second terminal of the ninth transistor Q9 and the first terminal of the tenth transistor Q10 and between the second terminal of the thirteenth transistor Q13 and the first terminal of the fourteenth transistor Q14, and a second terminal of the fourth capacitor C4 is electrically connected between the second terminal of the eleventh transistor Q11 and the first terminal of the twelfth transistor Q12 and between the second terminal of the fifteenth transistor Q15 and the first terminal of the sixteenth transistor Q16. The first terminal of the fourth capacitor C4 is an input terminal, and the second terminal of the fourth capacitor C4 is an output terminal.

Further, each of the first charge-discharge circuit and the second charge-discharge circuit may further include a plurality of capacitors that are connected in series, or connected in parallel, or connected in series and in parallel.

The first terminal of the inductive charge transfer circuit is electrically connected to the second terminal of the third capacitor C3 via a first node A1, wherein the first node A1 is disposed between a node connecting the second terminal of the third capacitor C3 to the first branch and a node connecting the second terminal of the third capacitor to the second branch. The second terminal of the inductive charge transfer circuit is electrically connected to the second terminal of the fourth capacitor C4 via a second node A2, wherein the second node A2 is disposed between a node connecting the second terminal of the fourth capacitor C4 to the third branch and a node connecting the second terminal of the fourth capacitor C4 to the fourth branch. The first terminals of the transistors are all drains, the second terminals of the transistors are all sources, and the drive terminals of the transistors are all gates.

The transistor control circuit includes a first output terminal B1, a second output terminal B2, a third output terminal B3 and a fourth output terminal B4. The first output terminal B1 is configured to output a control signal for controlling the first transistor Q1, the third transistor Q3, the fourteenth transistor Q14, and the sixteenth transistor Q16. The second output terminal B2 is configured to output a control signal for controlling the second transistor Q2, the fourth transistor Q4, the thirteenth transistor Q13, and the fifteenth transistor Q15.

Further, the transistor control circuit may be further configured to: in a case where the load capacity of the load is greater than or equal to the predetermined threshold, control the first branch and the second branch to be in the first ON state and the third branch and the fourth branch to be in the second ON state, then control the first branch, the second branch, the third branch, and the fourth branch to be in the OFF state, and subsequently control the first branch and the second branch to be in the second ON state and the third branch and the fourth branch to be in the first ON state.

In a case where the output terminal of the switched-capacitor voltage converter is electrically connected to a load with a load capacity greater than or equal to the predetermined threshold, considering the settings for reducing conduction loss, at least part of the transistors in the first branch are caused to be turned on, and at least part of the transistors in the second branch are caused to be turned on. In a case where the clock signal is in the third phase, that is, the first block is in the first state and the second block is in the second state, the first branch and the second branch are both in the first ON state, and the third branch and the fourth branch are both in the second ON state. In this case, the transistors in the first branch and the second branch that are electrically connected to the input terminal of the switched-capacitor voltage converter are all in the ON state, and the first branch and the second branch are configured to supply currents to the first charge-discharge circuit, such that the first charge-discharge circuit is in the charging state; and the transistors in the third branch and the fourth branch that are electrically connected to the input terminal of the switched-capacitor voltage converter are all in the OFF state, and the second charge-discharge circuit is in the discharging state to supply currents to the third branch and the fourth branch.

In a case where the clock signal is in the fourth phase, that is, the first block is in the second state and the second block is in the first state, the first branch and the second branch are both in the second ON state, and the third branch and the fourth branch are both in the first ON state. In this case, the transistors in the first branch and the second branch that are electrically connected to the input terminal of the switched-capacitor voltage converter are all in the OFF state, and the first charge-discharge circuit is in the discharging state to supply currents to the first branch and the second branch; and the transistors in the third branch and the fourth branch that are electrically connected to the input terminal of the switched-capacitor voltage converter are all on the ON state, and the third branch and the fourth branch supply currents to the second charge-discharge circuit so that the second charge-discharge circuit is in the charging state.

During running of the switched-capacitor voltage converter, in addition to a stage where the first branch, the second branch, the third branch, and the fourth branch are all in the OFF state, the first branch and the second branch in the first block and the third branch and the fourth branch in the second block are alternately in the first ON state or the second ON state such that the first block and the second block are alternately in the ON state.

In the above embodiments, in a case where the first branch is in the first ON state, the first transistor Q1 and the third transistor Q3 are in the ON state, and the second transistor Q2 and the fourth transistor Q4 are in the OFF state; or in a case where the first branch is in the second ON state, the first transistor Q1 and the third transistor Q3 are in the OFF state, and the second transistor Q2 and the fourth transistor Q4 are in the ON state.

In a case where the second branch is in the first ON state, the fifth transistor Q5 and the seventh transistor Q7 are in the ON state, and the sixth transistor Q6 and the eighth transistor Q8 are in the OFF state; or in a case where the second branch is in the second ON state, the fifth transistor Q5 and the seventh transistor Q7 are in the OFF state, and the sixth transistor Q6 and the eighth transistor Q8 are in the ON state.

In a case where the third branch is in the first ON state, the ninth transistor Q9 and the eleventh transistor Q11 are in the ON state, and the tenth transistor Q10 and the twelfth transistor Q12 are in the OFF state; or in a case where the third branch is in the second ON state, the ninth transistor Q9 and the eleventh transistor Q11 are in the OFF state, and the tenth transistor Q10 and the twelfth transistor Q12 are in the ON state.

In a case where the fourth branch is in the first ON state, the thirteenth transistor Q13 and the fifteenth transistor Q15 are in the ON state, and the fourteenth transistor Q14 and the sixteenth transistor Q16 are in the OFF state; or in a case where the fourth branch is in the second ON state, the thirteenth transistor Q13 and the fifteenth transistor Q15 are in the OFF state, and the fourteenth transistor Q14 and the sixteenth transistor Q16 are in the ON state.

Furthermore, based on the above description, the different states of the various transistors in the switched-capacitor voltage converter according to the present disclosure under different operating conditions are described in detail.

Since the switched-capacitor voltage converter according to the present disclosure is controlled based on a fixed-frequency clock signal, one operating cycle of the switched-capacitor voltage converter may be divided into: a first phase from 0 to T1, a second phase from T1 to T2, a third phase from T2 to T3, a fourth phase from T3 to T4, and a fifth phase from T4 to T5.

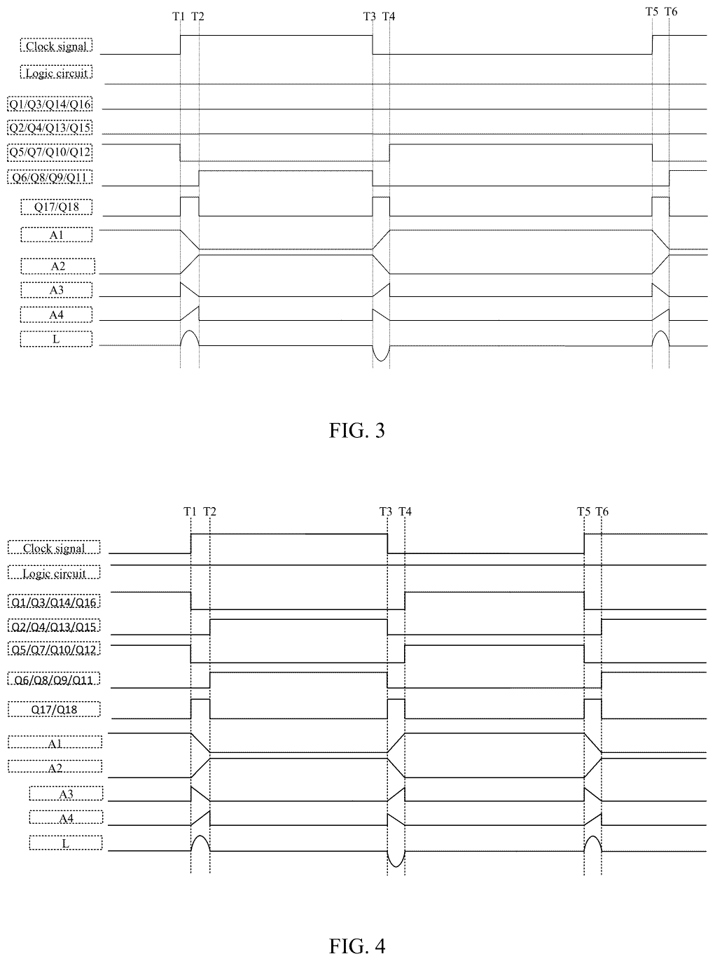

FIG. 3 is a diagram illustrating pulse waveforms of components and nodes in a case where a switched-capacitor voltage converter is electrically connected to a load with a load capacity being less than a predetermined threshold and runs according to some embodiments of the present disclosure.

As illustrated in FIG. 3, in a case where the load capacity of the load connected to the output terminal of the switched-capacitor voltage converter is less than the predetermined threshold, the transistor control circuit controls the first transistor Q1, the second transistor Q2, the third transistor Q3, the fourth transistor Q4, the thirteenth transistor Q13, a fourteenth transistor Q14, the fifteenth transistor Q15, and the sixteenth transistor Q16 to be constantly in the OFF state during one operating cycle of the switched-capacitor voltage converter.

As illustrated in FIG. 3, during the first phase from 0 to T1, the transistor control circuit controls the second branch to be in the first ON state and the third branch to be in the second ON state. That is, the fifth transistor Q5 and the seventh transistor Q7 are in the ON state, the sixth transistor Q6 and the eighth transistor Q8 are in the OFF state, the ninth transistor Q9 and the eleventh transistor Q11 are in the OFF state, and the tenth transistor Q10 and the twelfth transistor Q12 are in the ON state. In this case, a voltage at the first node A1 is an output voltage of the switched-capacitor voltage converter, and the second node A2 is grounded, such that a voltage at the second node A2 is zero.

As illustrated in FIG. 3, during the second phase from T1 to T2, the transistor control circuit controls the fifth transistor Q5, the sixth transistor Q6, the seventh transistor Q7, the eighth transistor Q8, the ninth transistor Q9, the tenth transistor Q10, the eleventh transistor Q11, and the twelfth transistor Q12 to be all in the OFF state. The inductive charge transfer circuit is turned on. In this case, charges on the third capacitor C3 electrically connected to the first node A1 are transferred via the inductive charge transfer circuit to the fourth capacitor C4 electrically connected to the second node A2, such that the voltage at the first node A1 progressively decreases and the voltage at the second node A2 progressively increases.

As illustrated in FIG. 3, during the third phase from T2 to T3, under control by the transistor control circuit and transfer of charges during the second phase from T1 to T2, the ninth transistor Q9 and the eleventh transistor Q11 are in the ON state, the tenth transistor Q10 and the twelfth transistor Q12 are in the OFF state, the fifth transistor Q5 and the seventh transistor Q7 are in the OFF state, the sixth transistor Q6 and the eighth transistor Q8 are in the ON state. In this case, the transistor control circuit controls the inductive charge transfer circuit to be in the OFF state. Concurrently, the voltage at the first node A1 is zero, and the voltage at the second node A2 is the output voltage of the switched-capacitor voltage converter.

As illustrated in FIG. 3, during the fourth phase from T3 to T4, the transistor control circuit controls the fifth transistor Q5, the sixth transistor Q6, the seventh transistor Q7, the eighth transistor Q8, the ninth transistor Q9, the tenth transistor Q10, the eleventh transistor Q11, and the twelfth transistor Q12 to be all in the OFF state. The inductive charge transfer circuit is turned on. In this case, charges on the fourth capacitor C4 electrically connected to the second node A2 are transferred via the inductive charge transfer circuit to the third capacitor C3 electrically connected to the first node A1, such that the voltage at the second node A2 progressively decreases and the voltage at the first node A1 progressively increases.

As illustrated in FIG. 3, during the fifth phase from T4 to T5, under control by the transistor control circuit and transfer of charges during the fourth phase from T3 to T4, the fifth transistor Q5 and the seventh transistor Q7 are in the ON state, the sixth transistor Q6 and the eighth transistor Q8 are in the OFF state, the ninth transistor Q9 and the eleventh transistor Q11 are in the OFF state, the tenth transistor Q10 and the twelfth transistor Q12 are in the ON state. In this case, the transistor control circuit controls the inductive charge transfer circuit to be in the OFF state. Concurrently, the voltage at the second node A2 is zero, and the voltage at the first node A1 is the output voltage of the switched-capacitor voltage converter.

Additionally, as illustrated in FIG. 3, during a phase from T5 to T6, the transistor control signal generated by the transistor control circuit is consistent with the transistor control signal generated by the transistor control circuit during the second phase from T1 to T2. In a phase subsequent to T6, the transistor control signal generated by the transistor control circuit is consistent with the transistor control signal generated by the transistor control circuit during the third phase from T2 to T3.

FIG. 4 is a diagram illustrating pulse waveforms of components and nodes in a case where a switched-capacitor voltage converter is electrically connected to a load with a load capacity greater than or equal to a predetermined threshold and runs according to some embodiments of the present disclosure.

As illustrated in FIG. 4, in a case where the switched-capacitor voltage converter is electrically connected to the load with the load capacity greater than or equal to the predetermined threshold, the transistors that are configured to be simultaneously turned on or turned off in the first branch and the second branch are turned on or turned off simultaneously, and the transistors that are configured to be simultaneously turned on or turned off in the third branch and the fourth branch are simultaneously turned on or turned off.

As illustrated in FIG. 4, during the first phase from 0 to T1, the transistor control circuit controls the first transistor Q1, the third transistor Q3, the fifth transistor Q5, and the seventh transistor Q7 to be in the ON state, and controls the second transistor Q2, the fourth transistor Q4, the sixth transistor Q6, and the eighth transistor Q8 to be in the OFF state. In this case, the voltage at the first node A1 is the output voltage of the switched-capacitor voltage converter, and the second node A2 is grounded, such that the voltage at the second node A2 is zero.

As illustrated in FIG. 4, during the second phase from T1 to T2, the transistor control circuit controls the first transistor Q1, the second transistor Q2, the third transistor Q3, the fourth transistor Q4, the fifth transistor Q5, the sixth transistor Q6, the seventh transistor Q7, the eighth transistor Q8, the ninth transistor Q9, the tenth transistor Q10, the eleventh transistor Q11, the twelfth transistor Q12, the thirteenth transistor Q13, the fourteenth transistor Q14, the fifteenth transistor Q15, and the sixteenth transistor Q16 to be all in the OFF state. The inductive charge transfer circuit is turned on. In this case, charges on the third capacitor C3 electrically connected to the first node A1 are transferred via the inductive charge transfer circuit to the fourth capacitor C4 electrically connected to the second node A2, such that the voltage at the first node A1 progressively decreases and the voltage at the second node A2 progressively increases.

As illustrated in FIG. 4, during the third phase from T2 to T3, under control by the transistor control circuit and transfer of charges during the second phase from T1 to T2, the ninth transistor Q9, the eleventh transistor Q11, the thirteenth transistor Q13, and the fifteenth transistor Q15 are all in the ON state, the tenth transistor Q10, the twelfth transistor Q12, the fourteenth transistor Q14, and the sixteenth transistor Q16 are all in the OFF state, the first transistor Q1, the third transistor Q3, the fifth transistor Q5, and the seventh transistor Q7 are all in the OFF state, and the second transistor Q2, the fourth transistor Q4, the sixth transistor Q6, and the eighth transistor Q8 are all in the ON state. In this case, the transistor control circuit controls the inductive charge transfer circuit to be in the OFF state. Concurrently, the voltage at the first node A1 is zero, and the voltage at the second node A2 is the output voltage of the switched-capacitor voltage converter.

As illustrated in FIG. 4, during the fourth phase from T3 to T4, the transistor control circuit controls the first transistor Q1, the second transistor Q2, the third transistor Q3, the fourth transistor Q4, the fifth transistor Q5, the sixth transistor Q6, the seventh transistor Q7, the eighth transistor Q8, the ninth transistor Q9, the tenth transistor Q10, the eleventh transistor Q1l, the twelfth transistor Q12, the thirteenth transistor Q13, the fourteenth transistor Q14, the fifteenth transistor Q15, and the sixteenth transistor Q16 to be all in the OFF state. The inductive charge transfer circuit is turned on. In this case, charges on the fourth capacitor C4 electrically connected to the second node A2 are transferred via the inductive charge transfer circuit to the third capacitor C3 electrically connected to the first node A1, such that the voltage at the second node A2 progressively decreases and the voltage at the first node A1 progressively increases.

As illustrated in FIG. 4, during the fifth phase from T4 to T5, under control by the transistor control circuit and transfer of charges during the fourth phase from T3 to T4, the first transistor Q1, the third transistor Q3, the fifth transistor Q5, and the seventh transistor Q7 are all in the ON state, the second transistor Q2, the fourth transistor Q4, the sixth transistor Q6, and the eighth transistor Q8 are all in the OFF state, the ninth transistor Q9, the eleventh transistor Q11, the thirteenth transistor Q13, and the fifteenth transistor Q15 are all in the OFF state, and the tenth transistor Q10, the twelfth transistor Q12, the fourteenth transistor Q14, and the sixteenth transistor Q16 are in the ON state. In this case, the transistor control circuit controls the inductive charge transfer circuit to be in the OFF state. Concurrently, the voltage at the second node A2 is zero, and the voltage at the first node A1 is the output voltage of the switched-capacitor voltage converter.

Additionally, as illustrated in FIG. 4, during the phase from T5 to T6, transistor control signals generated by the transistor control circuit is consistent with the transistor control signals generated by the transistor control circuit during the second phase from T1 to T2. In a phase subsequent to T6, the transistor control signals generated by the transistor control circuit are consistent with the transistor control signals generated by the transistor control circuit during the third phase from T2 to T3.

Further, a size of each of the transistors in the first branch is at least twice a size of each of the transistors in the second branch; and a size of each of the transistors in the fourth branch is at least twice a size of each of the transistors in the third branch.

The size of each of the plurality of transistors in the first branch is at least twice the size of each of the plurality of transistors in the second branch, and the size of each of the plurality of transistors in the fourth branch is at least twice the size of each of the plurality of transistors in the third branch. Based on such configurations, the transistors in the first branch and the fourth branch have a larger size relative to the transistors in the second branch and the third branch, such that the transistors with a smaller size may only be turned on in a case where the load capacity of the load electrically connected to the switched-capacitor voltage converter is smaller. In this way, the capacitive loss and drive loss in the switched-capacitor voltage converter are effectively reduced, and hence the conversion efficiency of the switched-capacitor voltage converter is improved.

Referring to FIG. 2, further, the inductive charge transfer circuit includes a seventeenth transistor Q17, an eighteenth transistor Q18, and an inductor L.

A first terminal of the seventeenth transistor Q17 is electrically connected to the second terminal of the first charge-discharge circuit, a second terminal of the seventeenth transistor Q17 is electrically connected to a first terminal of the inductor L, a second terminal of the inductor L is electrically connected to a second terminal of the eighteenth transistor Q18, and a first terminal of the eighteenth transistor Q18 is electrically connected to the second terminal of the second charge-discharge circuit.

In the switched-capacitor voltage converter, via the inductive charge transfer circuit, charges on the first node A1 are transferred to the second node A2, or charges on the second node A2 are transferred to the first node A1, such that the transistors in the first branch, the second branch, the third branch, and the fourth branch are turned on under a zero voltage. In this way, the drive loss and capacitive loss in the switched-capacitor voltage converter are reduced, and hence the conversion efficiency of the switched-capacitor voltage converter is improved.

Referring to FIG. 2, in the switched-capacitor voltage converter according to the present disclosure, the inductive charge transfer circuit includes the seventeenth transistor Q17, the eighteenth transistor Q18, and the inductor L. In a case where the inductive charge transfer circuit is turned on, the transistor control circuit controls the seventeenth transistor Q17 and the eighteenth transistor Q18 to be turned on. A first terminal of the seventeenth transistor Q17 is electrically connected to the second terminal of the third capacitor C3 via the first node A1, a drive terminal of the seventeenth transistor Q17 is electrically connected to the transistor control circuit via a transistor driver 1, and a second terminal of the seventeenth transistor Q17 is electrically connected to a first terminal of the inductor L via a third node A3. A second terminal of the eighteenth transistor Q18 is electrically connected to a second terminal of the inductor L via a fourth node A4, a drive terminal of the eighteenth transistor Q18 is electrically connected to the transistor control circuit via a transistor driver 1, and a first terminal of the eighteenth transistor Q18 is electrically connected to the second terminal of the fourth capacitor C4 via the second node A2. The transistor control circuit further includes a third output terminal B3. The third output terminal B3 is configured to output a control signal for controlling the seventeenth transistor Q17 and the eighteenth transistor Q18.

Referring to FIG. 2, further, the switched-capacitor voltage converter further includes a logic circuit 2, configured to control on or off of the transistors in the first branch and the fourth branch under control of the transistor control circuit.

Referring to FIG. 2, the switched-capacitor voltage converter includes the logic circuit 2. The logic circuit 2 is configured to control on or off of the transistors in the first branch and the fourth branch under control of the transistor control circuit in a case where it is determined that the load capacity of the load exceeds the predetermined threshold. In addition, no specific requirements are imposed on the position and type of the logic circuit 2 as long as the logic circuit 2 satisfies the above application requirements. In some embodiments, the logic circuit 2 may be disposed between the transistor control circuit and the drive terminals of the transistors in the first branch, and between the transistor control circuit and the drive terminals of the transistors in the fourth branch. In the design of the switched-capacitor voltage converter as illustrated in FIG. 2, the logic circuit 2 in the switched-capacitor voltage converter is an AND logic circuit 21, and the AND logic circuit 21 is electrically connected between the output terminal of the switched-capacitor voltage converter and a transistor driver 1. The transistor driver 1 is a transistor driver electrically connected to the transistors in the first branch and the fourth branch. In a case where the logic circuit 2 is disposed between the transistor control circuit and the drive terminals of the transistors in the first branch, the transistor control circuit further includes a fourth output terminal B4. The fourth output terminal B4 is configured to output a control signal for controlling the logic circuit 2.

In some other embodiments, the logic circuit 2 is integrated in the transistor control circuit.

In the above embodiments, the logic circuit 2 may be disposed between the transistor control circuit and the drive terminals of the transistors in the first branch, and between the transistor control circuit and the drive terminals of the transistors in the fourth branch. Optionally, the logic circuit 2 may also be disposed in the transistor control circuit, which is more conducive to controlling the logic circuit 2 by the transistor control circuit.

The number of branches, the number of transistors, the positions of transistors, the number of charge-discharge circuits, the number of capacitors in charge-discharge circuits, the position and type of the logic circuit 2 include, but are not limited to, the number of transistors, the positions of transistors, the number of charge-discharge circuits, the number of capacitors in charge-discharge circuits, the position and type of the logic circuit 2, which may be determined based on specific requirements in different embodiments.

Some embodiments of the present disclosure further provide a chip. The chip includes the switched-capacitor voltage converter according to any one of the above embodiments.

Some embodiments of the present disclosure provide an electronic device. The electronic device includes the chip according to the above embodiments.

What is claimed is:

1. A switched-capacitor voltage converter, comprising:
a first branch, a second branch, a third branch, a fourth branch, a first charge-discharge circuit, a second charge-discharge circuit, and a transistor control circuit; wherein
the first branch, the second branch, the third branch, and the fourth branch are all electrically connected between an input terminal and a ground terminal of the switched-capacitor voltage converter, and the first branch, the second branch, the third branch, and the fourth branch are all further electrically connected to an output terminal of the switched-capacitor voltage converter;
each of the first branch, the second branch, the third branch, and the fourth branch comprises a plurality of transistors, wherein transistors in the first branch and transistors in the second branch are configured to be simultaneously turned on or turned off and are of different sizes, transistors in the third branch and transistors in the fourth branch are configured to be simultaneously turned on or turned off and are of different sizes, the transistor control circuit is electrically connected to drive terminals of all the transistors in each of the first branch, the second branch, the third branch, and the fourth branch;
a first terminal of the first charge-discharge circuit is electrically connected to both the first branch and the second branch and is close to the input terminal of the switched-capacitor voltage converter, a second terminal of the first charge-discharge circuit is electrically connected to both the first branch and the second branch and is close to the ground terminal of the switched-capacitor voltage converter; and
a first terminal of the second charge-discharge circuit is electrically connected to both the third branch and the fourth branch and is close to the input terminal of the switched-capacitor voltage converter, a second terminal of the second charge-discharge circuit is electrically connected to both the third branch and the fourth branch and is close to the ground terminal of the switched-capacitor voltage converter.

2. The switched-capacitor voltage converter according to claim 1, further comprising: an inductive charge transfer circuit;
wherein a first terminal of the inductive charge transfer circuit is electrically connected to the second terminal of the first charge-discharge circuit, a second terminal of the inductive charge transfer circuit is electrically connected to the second terminal of the second charge-discharge circuit, and a drive terminal of the inductive charge transfer circuit is electrically connected to the transistor control circuit.

3. The switched-capacitor voltage converter according to claim 2, wherein the transistor control circuit is configured to control the inductive charge transfer circuit to be turned on in a case where the first branch, the second branch, the third branch, and the fourth branch are all in an OFF state; and
the transistor control circuit is further configured to: in a case where a load capacity of a load is less than a predetermined threshold, control the first branch and the fourth branch to be constantly in the OFF state and control the second branch to be in a first ON state and the third branch to be in a second ON state, then control the second branch and the third branch to be in the OFF state and subsequently control the second branch to be in the second ON state and the third branch to be in the first ON state.

4. The switched-capacitor voltage converter according to claim 2, wherein the transistor control circuit is configured to control the inductive charge transfer circuit to be turned on in a case where the first branch, the second branch, the third branch, and the fourth branch are all in an OFF state; and
the transistor control circuit is further configured to: in a case where a load capacity of a load is greater than or equal to a predetermined threshold, control the first branch and the second branch to be in a first ON state and the third branch and the fourth branch to be in a second ON state, then control the first branch, the second branch, the third branch, and the fourth branch to be in the OFF state, and subsequently control the first branch and the second branch to be in the second ON state and the third branch and the fourth branch to be in the first ON state.

5. The switched-capacitor voltage converter according to claim 1, wherein
the first branch comprises a first transistor, a second transistor, a third transistor, and a fourth transistor, wherein a first terminal of the first transistor is electrically connected to the input terminal of the switched-capacitor voltage converter, a drive terminal of the first transistor is electrically connected to the transistor control circuit, a second terminal of the first transistor is electrically connected to a first terminal of the second transistor, a drive terminal of the second transistor is electrically connected to the transistor control circuit, a second terminal of the second transistor is electrically connected to a first terminal of the third transistor, a drive terminal of the third transistor is electrically connected to the transistor control circuit, a second terminal of the third transistor is electrically connected to a first terminal of the fourth transistor, a drive terminal of the fourth transistor is electrically connected to the transistor control circuit, and a second terminal of the fourth transistor is electrically connected to the ground terminal of the switched-capacitor voltage converter;
the second branch comprises a fifth transistor, a sixth transistor, a seventh transistor, and an eighth transistor, wherein a first terminal of the fifth transistor is electrically connected to the input terminal of the switched-capacitor voltage converter, a drive terminal of the fifth transistor is electrically connected to the transistor control circuit, a second terminal of the fifth transistor is electrically connected to a first terminal of the sixth transistor, a drive terminal of the sixth transistor is electrically connected to the transistor control circuit, a second terminal of the sixth transistor is electrically connected to a first terminal of the seventh transistor, a drive terminal of the seventh transistor is electrically connected to the transistor control circuit, a second terminal of the seventh transistor is electrically connected to a first terminal of the eighth transistor, a drive terminal of the eighth transistor is electrically connected to the transistor control circuit, and a second terminal of the eighth transistor is electrically connected to the ground terminal of the switched-capacitor voltage converter;
the third branch comprises a ninth transistor, a tenth transistor, an eleventh transistor, and a twelfth transistor, wherein a first terminal of the ninth transistor is electrically connected to the input terminal of the switched-capacitor voltage converter, a drive terminal of the ninth transistor is electrically connected to the transistor control circuit, a second terminal of the ninth transistor is electrically connected to a first terminal of the tenth transistor, a drive terminal of the tenth transistor is electrically connected to the transistor control circuit, a second terminal of the tenth transistor is electrically connected to a first terminal of the eleventh transistor, a drive terminal of the eleventh transistor is electrically connected to the transistor control circuit, a second terminal of the eleventh transistor is electrically connected to a first terminal of the twelfth transistor, a drive terminal of the twelfth transistor is electrically connected to the transistor control circuit, and a second terminal of the twelfth transistor is electrically connected to the ground terminal of the switched-capacitor voltage converter;
the fourth branch comprises a thirteenth transistor, a fourteenth transistor, a fifteenth transistor, and a sixteenth transistor, wherein a first terminal of the thirteenth transistor is electrically connected to the input terminal of the switched-capacitor voltage converter, a drive terminal of the thirteenth transistor is electrically connected to the transistor control circuit, a second terminal of the thirteenth transistor is electrically connected to a first terminal of the fourteenth transistor, a drive terminal of the fourteenth transistor is electrically connected to the transistor control circuit, a second terminal of the fourteenth transistor is electrically connected to a first terminal of the fifteenth transistor, a drive terminal of the fifteenth transistor is electrically connected to the transistor control circuit, a second terminal of the fifteenth transistor is electrically connected to a first terminal of the sixteenth transistor, a drive terminal of the sixteenth transistor is electrically connected to the transistor control circuit, and a second terminal of the sixteenth transistor is electrically connected to the ground terminal of the switched-capacitor voltage converter;
the first terminal of the first charge-discharge circuit is electrically connected between the second terminal of the first transistor and the first terminal of the second transistor and between the second terminal of the fifth transistor and the first terminal of the sixth transistor, and the second terminal of the first charge-discharge circuit is electrically connected between the second terminal of the third transistor and the first terminal of the fourth transistor and between the second terminal of the seventh transistor and the first terminal of the eighth transistor; and
the first terminal of the second charge-discharge circuit is electrically connected between the second terminal of the ninth transistor and the first terminal of the tenth transistor and between the second terminal of the thirteenth transistor and the first terminal of the fourteenth transistor, and the second terminal of the second charge-discharge circuit is electrically connected between the second terminal of the eleventh transistor and the first terminal of the twelfth transistor and between the second terminal of the fifteenth transistor and the first terminal of the sixteenth transistor.

6. The switched-capacitor voltage converter according to claim 5, wherein a size of each of the transistors in the first branch is at least twice a size of each of the transistors in the second branch; and
a size of each of the transistors in the fourth branch is at least twice a size of each of the transistors in the third branch.

7. The switched-capacitor voltage converter according to claim 5, wherein in a case where the first branch is in a first ON state, the first transistor and the third transistor are in an ON state, and the second transistor and the fourth transistor are in an OFF state; or in a case where the first branch is in a second ON state, the first transistor and the third transistor are in an OFF state, and the second transistor and the fourth transistor are in an ON state;
in a case where the second branch is in a first ON state, the fifth transistor and the seventh transistor are in an ON state, and the sixth transistor and the eighth transistor are in an OFF state; or in a case where the second branch is in a second ON state, the fifth transistor and the seventh transistor are in an OFF state, and the sixth transistor and the eighth transistor are in an ON state;
in a case where the third branch is in a first ON state, the ninth transistor and the eleventh transistor are in an ON state, and the tenth transistor and the twelfth transistor are in an OFF state; or in a case where the third branch is in a second ON state, the ninth transistor and the eleventh transistor are in an OFF state, and the tenth transistor and the twelfth transistor are in an ON state; and
in a case where the fourth branch is in a first ON state, the thirteenth transistor and the fifteenth transistor are in an ON state, and the fourteenth transistor and the sixteenth transistor are in an OFF state; or in a case where the fourth branch is in a second ON state, the thirteenth transistor and the fifteenth transistor are in an OFF state, and the fourteenth transistor and the sixteenth transistor are in an ON state.

8. The switched-capacitor voltage converter according to claim 5, wherein the second terminal of the first charge-discharge circuit is electrically connected to a first node which is electrically connected to the second terminal of the third transistor, the first terminal of the fourth transistor, the second terminal of the seventh transistor, and the first terminal of the eighth transistor, the second terminal of the second charge-discharge circuit is electrically connected to a second node which is electrically connected to the second terminal of the eleventh transistor, the first terminal of the twelfth transistor, the second terminal of the fifteenth transistor, and the first terminal of the sixteenth transistor, and an inductive charge transfer circuit is electrically connected between the first node and the second node; and one operating cycle of the switched-capacitor voltage converter comprises: a first phase from 0 to T1, a second phase from T1 to T2, a third phase from T2 to T3, a fourth phase from T3 to T4, and a fifth phase from T4 to T5; wherein,
in a case where a load capacity of a load connected to the output terminal of the switched-capacitor voltage converter is less than a predetermined threshold:
the transistor control circuit is configured to control the first transistor, the second transistor, the third transistor, the fourth transistor, the thirteenth transistor, a fourteenth transistor, the fifteenth transistor, and the sixteenth transistor to be constantly in an OFF state during the one operating cycle;
the transistor control circuit is further configured to, during the first phase from 0 to T1, control the fifth transistor and the seventh transistor to be in an ON state, the sixth transistor and the eighth transistor to be in the OFF state, the ninth transistor and the eleventh transistor to be in the OFF state, and the tenth transistor and the twelfth transistor to be in the ON state so that a voltage at the first node is an output voltage of the switched-capacitor voltage converter, and the second node is grounded;
the transistor control circuit is further configured to, during the second phase from T1 to T2, control the fifth transistor, the sixth transistor, the seventh transistor, the eighth transistor, the ninth transistor, the tenth transistor, the eleventh transistor, and the twelfth transistor to be all in the OFF state, and control the inductive charge transfer circuit to be turned on so that charges on the first charge-discharge circuit are transferred via the inductive charge transfer circuit to the second charge-discharge circuit;
the transistor control circuit is further configured to, during the third phase from T2 to T3, control the ninth transistor and the eleventh transistor to be in the ON state, the tenth transistor and the twelfth transistor to be in the OFF state, the fifth transistor and the seventh transistor to be in the OFF state, the sixth transistor and the eighth transistor to be in the ON state, and control the inductive charge transfer circuit to be in the OFF state so that the voltage at the first node is zero, and a voltage at the second node is the output voltage of the switched-capacitor voltage converter;
the transistor control circuit is further configured to, during the fourth phase from T3 to T4, control the fifth transistor, the sixth transistor, the seventh transistor, the eighth transistor, the ninth transistor, the tenth transistor, the eleventh transistor, and the twelfth transistor to be all in the OFF state, and control the inductive charge transfer circuit to be turned on so that charges on the second charge-discharge circuit are transferred via the inductive charge transfer circuit to the first charge-discharge circuit;
the transistor control circuit is further configured to, during the fifth phase from T4 to T5, the fifth transistor and the seventh transistor to be in the ON state, the sixth transistor and the eighth transistor to be in the OFF state, the ninth transistor and the eleventh transistor to be in the OFF state, the tenth transistor and the twelfth transistor to be in the ON state, and control the inductive charge transfer circuit to be in the OFF state so that the voltage at the second node is zero, and the voltage at the first node is the output voltage of the switched-capacitor voltage converter.

9. The switched-capacitor voltage converter according to claim 5, wherein the second terminal of the first charge-discharge circuit is electrically connected to a first node which is electrically connected to the second terminal of the third transistor, the first terminal of the fourth transistor, the second terminal of the seventh transistor, and the first terminal of the eighth transistor, the second terminal of the second charge-discharge circuit is electrically connected to a second node which is electrically connected to the second terminal of the eleventh transistor, the first terminal of the twelfth transistor, the second terminal of the fifteenth transistor, and the first terminal of the sixteenth transistor, and an inductive charge transfer circuit is electrically connected between the first node and the second node; and one operating cycle of the switched-capacitor voltage converter comprises: a first phase from 0 to T1, a second phase from T1 to T2, a third phase from T2 to T3, a fourth phase from T3 to T4, and a fifth phase from T4 to T5; wherein,
in a case where the switched-capacitor voltage converter is electrically connected to a load with a load capacity greater than or equal to a predetermined threshold:
the transistor control circuit is configured to, during the first phase from 0 to T1, control the first transistor, the third transistor, the fifth transistor, and the seventh transistor to be in an ON state, and control the second transistor, the fourth transistor, the sixth transistor, and the eighth transistor to be in an OFF state so that a voltage at the first node is an output voltage of the switched-capacitor voltage converter, and the second node is grounded;
the transistor control circuit is further configured to, during the second phase from T1 to T2, control the first transistor, the second transistor, the third transistor, the fourth transistor, the fifth transistor, the sixth transistor, the seventh transistor, the eighth transistor, the ninth transistor, the tenth transistor, the eleventh transistor, the twelfth transistor, the thirteenth transistor, the fourteenth transistor, the fifteenth transistor, and the sixteenth transistor to be all in the OFF state, and control the inductive charge transfer circuit to be turned on so that charges on the first charge-discharge circuit are transferred via the inductive charge transfer circuit to the second charge-discharge circuit;
the transistor control circuit is further configured to, during the third phase from T2 to T3, control the ninth transistor, the eleventh transistor, the thirteenth transistor, and the fifteenth transistor to be all in the ON state, the tenth transistor, the twelfth transistor, the fourteenth transistor, and the sixteenth transistor to be all in the OFF state, the first transistor, the third transistor, the fifth transistor, and the seventh transistor to be all in the OFF state, and the second transistor, the fourth transistor, the sixth transistor, and the eighth transistor to be all in the ON state, and control the inductive charge transfer circuit to be in the OFF state so that the voltage at the first node is zero, and a voltage at the second node is the output voltage of the switched-capacitor voltage converter;
the transistor control circuit is further configured to, during the fourth phase from T3 to T4, control the first transistor, the second transistor, the third transistor, the fourth transistor, the fifth transistor, the sixth transistor, the seventh transistor, the eighth transistor, the ninth transistor, the tenth transistor, the eleventh transistor, the twelfth transistor, the thirteenth transistor, the fourteenth transistor, the fifteenth transistor, and the sixteenth transistor to be all in the OFF state, and control the inductive charge transfer circuit to be turned on so that charges on the second charge-discharge circuit are transferred via the inductive charge transfer circuit to the first charge-discharge circuit;
the transistor control circuit is further configured to, during the fifth phase from T4 to T5, control the first transistor, the third transistor, the fifth transistor, and the seventh transistor to be all in the ON state, the second transistor, the fourth transistor, the sixth transistor, and the eighth transistor to be all in the OFF state, the ninth transistor, the eleventh transistor, the thirteenth transistor, and the fifteenth transistor to be all in the OFF state, and the tenth transistor, the twelfth transistor, the fourteenth transistor, and the sixteenth transistor to be in the ON state, and control the inductive charge transfer circuit to be in the OFF state so that the voltage at the second node is zero, and the voltage at the first node is the output voltage of the switched-capacitor voltage converter.

10. The switched-capacitor voltage converter according to claim 1, wherein the inductive charge transfer circuit comprises a seventeenth transistor, an eighteenth transistor, and an inductor;
wherein a first terminal of the seventeenth transistor is electrically connected to the second terminal of the first charge-discharge circuit, a second terminal of the seventeenth transistor is electrically connected to a first terminal of the inductor, a second terminal of the inductor is electrically connected to a second terminal of the eighteenth transistor, and a first terminal of the eighteenth transistor is electrically connected to the second terminal of the second charge-discharge circuit.

11. The switched-capacitor voltage converter according to claim 1, wherein the inductive charge transfer circuit comprises a seventeenth transistor, an eighteenth transistor, and an inductor, the first charge-discharge circuit comprises a third capacitor, and the second charge-discharge circuit comprises a fourth capacitor, wherein,
a first terminal of the seventeenth transistor is electrically connected to a second terminal of the third capacitor, a drive terminal of the seventeenth transistor is electrically connected to the transistor control circuit via a transistor driver, and a second terminal of the seventeenth transistor is electrically connected to a first terminal of the inductor, a second terminal of the inductor is electrically connected to a second terminal of the eighteenth transistor, a drive terminal of the eighteenth transistor is electrically connected to the transistor control circuit via a transistor driver, and a first terminal of the eighteenth transistor is electrically connected to a second terminal of the fourth capacitor.

12. A chip, comprising: a switched-capacitor voltage converter, wherein the switched-capacitor voltage converter comprises a first branch, a second branch, a third branch, a fourth branch, a first charge-discharge circuit, a second charge-discharge circuit, and a transistor control circuit; wherein
the first branch, the second branch, the third branch, and the fourth branch are all electrically connected between an input terminal and a ground terminal of the switched-capacitor voltage converter, and the first branch, the second branch, the third branch, and the fourth branch are all further electrically connected to an output terminal of the switched-capacitor voltage converter;
each of the first branch, the second branch, the third branch, and the fourth branch comprises a plurality of transistors, wherein transistors in the first branch and transistors in the second branch are configured to be simultaneously turned on or turned off and are of different sizes, transistors in the third branch and transistors in the fourth branch are configured to be simultaneously turned on or turned off and are of different sizes, the transistor control circuit is electrically connected to drive terminals of all the transistors in each of the first branch, the second branch, the third branch, and the fourth branch;
a first terminal of the first charge-discharge circuit is electrically connected to both the first branch and the second branch and is close to the input terminal of the switched-capacitor voltage converter, a second terminal of the first charge-discharge circuit is electrically connected to both the first branch and the second branch and is close to the ground terminal of the switched-capacitor voltage converter; and
a first terminal of the second charge-discharge circuit is electrically connected to both the third branch and the fourth branch and is close to the input terminal of the switched-capacitor voltage converter, a second terminal of the second charge-discharge circuit is electrically connected to both the third branch and the fourth branch and is close to the ground terminal of the switched-capacitor voltage converter.

13. The chip according to claim 12, wherein the switched-capacitor voltage converter further comprises: an inductive charge transfer circuit;
wherein a first terminal of the inductive charge transfer circuit is electrically connected to the second terminal of the first charge-discharge circuit, a second terminal of the inductive charge transfer circuit is electrically connected to the second terminal of the second charge-discharge circuit, and a drive terminal of the inductive charge transfer circuit is electrically connected to the transistor control circuit.

14. The chip according to claim 13, wherein the transistor control circuit is configured to control the inductive charge transfer circuit to be turned on in a case where the first branch, the second branch, the third branch, and the fourth branch are all in an OFF state; and
the transistor control circuit is further configured to: in a case where a load capacity of a load is less than a predetermined threshold, control the first branch and the fourth branch to be constantly in the OFF state and control the second branch to be in a first ON state and the third branch to be in a second ON state, then control the second branch and the third branch to be in the OFF state and subsequently control the second branch to be in the second ON state and the third branch to be in the first ON state.

15. The chip according to claim 13, wherein the transistor control circuit is configured to control the inductive charge transfer circuit to be turned on in a case where the first branch, the second branch, the third branch, and the fourth branch are all in an OFF state; and
the transistor control circuit is further configured to: in a case where a load capacity of a load is greater than or equal to a predetermined threshold, control the first branch and the second branch to be in a first ON state and the third branch and the fourth branch to be in a second ON state, then control the first branch, the second branch, the third branch, and the fourth branch to be in the OFF state, and subsequently control the first branch and the second branch to be in the second ON state and the third branch and the fourth branch to be in the first ON state.

16. The chip according to claim 12, wherein
the first branch comprises a first transistor, a second transistor, a third transistor, and a fourth transistor, wherein a first terminal of the first transistor is electrically connected to the input terminal of the switched-capacitor voltage converter, a drive terminal of the first transistor is electrically connected to the transistor control circuit, a second terminal of the first transistor is electrically connected to a first terminal of the second transistor, a drive terminal of the second transistor is electrically connected to the transistor control circuit, a second terminal of the second transistor is electrically connected to a first terminal of the third transistor, a drive terminal of the third transistor is electrically connected to the transistor control circuit, a second terminal of the third transistor is electrically connected to a first terminal of the fourth transistor, a drive terminal of the fourth transistor is electrically connected to the transistor control circuit, and a second terminal of the fourth transistor is electrically connected to the ground terminal of the switched-capacitor voltage converter;
the second branch comprises a fifth transistor, a sixth transistor, a seventh transistor, and an eighth transistor, wherein a first terminal of the fifth transistor is electrically connected to the input terminal of the switched-capacitor voltage converter, a drive terminal of the fifth transistor is electrically connected to the transistor control circuit, a second terminal of the fifth transistor is electrically connected to a first terminal of the sixth transistor, a drive terminal of the sixth transistor is electrically connected to the transistor control circuit, a second terminal of the sixth transistor is electrically connected to a first terminal of the seventh transistor, a drive terminal of the seventh transistor is electrically connected to the transistor control circuit, a second terminal of the seventh transistor is electrically connected to a first terminal of the eighth transistor, a drive terminal of the eighth transistor is electrically connected to the transistor control circuit, and a second terminal of the eighth transistor is electrically connected to the ground terminal of the switched-capacitor voltage converter;
the third branch comprises a ninth transistor, a tenth transistor, an eleventh transistor, and a twelfth transistor, wherein a first terminal of the ninth transistor is electrically connected to the input terminal of the switched-capacitor voltage converter, a drive terminal of the ninth transistor is electrically connected to the transistor control circuit, a second terminal of the ninth transistor is electrically connected to a first terminal of the tenth transistor, a drive terminal of the tenth transistor is electrically connected to the transistor control circuit, a second terminal of the tenth transistor is electrically connected to a first terminal of the eleventh transistor, a drive terminal of the eleventh transistor is electrically connected to the transistor control circuit, a second terminal of the eleventh transistor is electrically connected to a first terminal of the twelfth transistor, a drive terminal of the twelfth transistor is electrically connected to the transistor control circuit, and a second terminal of the twelfth transistor is electrically connected to the ground terminal of the switched-capacitor voltage converter;
the fourth branch comprises a thirteenth transistor, a fourteenth transistor, a fifteenth transistor, and a sixteenth transistor, wherein a first terminal of the thirteenth transistor is electrically connected to the input terminal of the switched-capacitor voltage converter, a drive terminal of the thirteenth transistor is electrically connected to the transistor control circuit, a second terminal of the thirteenth transistor is electrically connected to a first terminal of the fourteenth transistor, a drive terminal of the fourteenth transistor is electrically connected to the transistor control circuit, a second terminal of the fourteenth transistor is electrically connected to a first terminal of the fifteenth transistor, a drive terminal of the fifteenth transistor is electrically connected to the transistor control circuit, a second terminal of the fifteenth transistor is electrically connected to a first terminal of the sixteenth transistor, a drive terminal of the sixteenth transistor is electrically connected to the transistor control circuit, and a second terminal of the sixteenth transistor is electrically connected to the ground terminal of the switched-capacitor voltage converter;
the first terminal of the first charge-discharge circuit is electrically connected between the second terminal of the first transistor and the first terminal of the second transistor and between the second terminal of the fifth transistor and the first terminal of the sixth transistor, and the second terminal of the first charge-discharge circuit is electrically connected between the second terminal of the third transistor and the first terminal of the fourth transistor and between the second terminal of the seventh transistor and the first terminal of the eighth transistor; and
the first terminal of the second charge-discharge circuit is electrically connected between the second terminal of the ninth transistor and the first terminal of the tenth transistor and between the second terminal of the thirteenth transistor and the first terminal of the fourteenth transistor, and the second terminal of the second charge-discharge circuit is electrically connected between the second terminal of the eleventh transistor and the first terminal of the twelfth transistor and between the second terminal of the fifteenth transistor and the first terminal of the sixteenth transistor.

17. The chip according to claim 12, wherein the inductive charge transfer circuit comprises a seventeenth transistor, an eighteenth transistor, and an inductor, the first charge-discharge circuit comprises a third capacitor, and the second charge-discharge circuit comprises a fourth capacitor, wherein,
a first terminal of the seventeenth transistor is electrically connected to a second terminal of the third capacitor, a drive terminal of the seventeenth transistor is electrically connected to the transistor control circuit via a transistor driver, and a second terminal of the seventeenth transistor is electrically connected to a first terminal of the inductor, a second terminal of the inductor is electrically connected to a second terminal of the eighteenth transistor, a drive terminal of the eighteenth transistor is electrically connected to the transistor control circuit via a transistor driver, and a first terminal of the eighteenth transistor is electrically connected to a second terminal of the fourth capacitor.

18. An electronic device, comprising: a switched-capacitor voltage converter, wherein the switched-capacitor voltage converter comprises a first branch, a second branch, a third branch, a fourth branch, a first charge-discharge circuit, a second charge-discharge circuit, and a transistor control circuit; wherein
the first branch, the second branch, the third branch, and the fourth branch are all electrically connected between an input terminal and a ground terminal of the switched-capacitor voltage converter, and the first branch, the second branch, the third branch, and the fourth branch are all further electrically connected to an output terminal of the switched-capacitor voltage converter;
each of the first branch, the second branch, the third branch, and the fourth branch comprises a plurality of transistors, wherein transistors in the first branch and transistors in the second branch are configured to be simultaneously turned on or turned off and are of different sizes, transistors in the third branch and transistors in the fourth branch are configured to be simultaneously turned on or turned off and are of different sizes, the transistor control circuit is electrically connected to drive terminals of all the transistors in each of the first branch, the second branch, the third branch, and the fourth branch;
a first terminal of the first charge-discharge circuit is electrically connected to both the first branch and the second branch and is close to the input terminal of the switched-capacitor voltage converter, a second terminal of the first charge-discharge circuit is electrically connected to both the first branch and the second branch and is close to the ground terminal of the switched-capacitor voltage converter; and
a first terminal of the second charge-discharge circuit is electrically connected to both the third branch and the fourth branch and is close to the input terminal of the switched-capacitor voltage converter, a second terminal of the second charge-discharge circuit is electrically connected to both the third branch and the fourth branch and is close to the ground terminal of the switched-capacitor voltage converter.

19. The electronic device according to claim 18, wherein
the first branch comprises a first transistor, a second transistor, a third transistor, and a fourth transistor, wherein a first terminal of the first transistor is electrically connected to the input terminal of the switched-capacitor voltage converter, a drive terminal of the first transistor is electrically connected to the transistor control circuit, a second terminal of the first transistor is electrically connected to a first terminal of the second transistor, a drive terminal of the second transistor is electrically connected to the transistor control circuit, a second terminal of the second transistor is electrically connected to a first terminal of the third transistor, a drive terminal of the third transistor is electrically connected to the transistor control circuit, a second terminal of the third transistor is electrically connected to a first terminal of the fourth transistor, a drive terminal of the fourth transistor is electrically connected to the transistor control circuit, and a second terminal of the fourth transistor is electrically connected to the ground terminal of the switched-capacitor voltage converter;
the second branch comprises a fifth transistor, a sixth transistor, a seventh transistor, and an eighth transistor, wherein a first terminal of the fifth transistor is electrically connected to the input terminal of the switched-capacitor voltage converter, a drive terminal of the fifth transistor is electrically connected to the transistor control circuit, a second terminal of the fifth transistor is electrically connected to a first terminal of the sixth transistor, a drive terminal of the sixth transistor is electrically connected to the transistor control circuit, a second terminal of the sixth transistor is electrically connected to a first terminal of the seventh transistor, a drive terminal of the seventh transistor is electrically connected to the transistor control circuit, a second terminal of the seventh transistor is electrically connected to a first terminal of the eighth transistor, a drive terminal of the eighth transistor is electrically connected to the transistor control circuit, and a second terminal of the eighth transistor is electrically connected to the ground terminal of the switched-capacitor voltage converter;
the third branch comprises a ninth transistor, a tenth transistor, an eleventh transistor, and a twelfth transistor, wherein a first terminal of the ninth transistor is electrically connected to the input terminal of the switched-capacitor voltage converter, a drive terminal of the ninth transistor is electrically connected to the transistor control circuit, a second terminal of the ninth transistor is electrically connected to a first terminal of the tenth transistor, a drive terminal of the tenth transistor is electrically connected to the transistor control circuit, a second terminal of the tenth transistor is electrically connected to a first terminal of the eleventh transistor, a drive terminal of the eleventh transistor is electrically connected to the transistor control circuit, a second terminal of the eleventh transistor is electrically connected to a first terminal of the twelfth transistor, a drive terminal of the twelfth transistor is electrically connected to the transistor control circuit, and a second terminal of the twelfth transistor is electrically connected to the ground terminal of the switched-capacitor voltage converter;
the fourth branch comprises a thirteenth transistor, a fourteenth transistor, a fifteenth transistor, and a sixteenth transistor, wherein a first terminal of the thirteenth transistor is electrically connected to the input terminal of the switched-capacitor voltage converter, a drive terminal of the thirteenth transistor is electrically connected to the transistor control circuit, a second terminal of the thirteenth transistor is electrically connected to a first terminal of the fourteenth transistor, a drive terminal of the fourteenth transistor is electrically connected to the transistor control circuit, a second terminal of the fourteenth transistor is electrically connected to a first terminal of the fifteenth transistor, a drive terminal of the fifteenth transistor is electrically connected to the transistor control circuit, a second terminal of the fifteenth transistor is electrically connected to a first terminal of the sixteenth transistor, a drive terminal of the sixteenth transistor is electrically connected to the transistor control circuit, and a second terminal of the sixteenth transistor is electrically connected to the ground terminal of the switched-capacitor voltage converter;
the first terminal of the first charge-discharge circuit is electrically connected between the second terminal of the first transistor and the first terminal of the second transistor and between the second terminal of the fifth transistor and the first terminal of the sixth transistor, and the second terminal of the first charge-discharge circuit is electrically connected between the second terminal of the third transistor and the first terminal of the fourth transistor and between the second terminal of the seventh transistor and the first terminal of the eighth transistor; and
the first terminal of the second charge-discharge circuit is electrically connected between the second terminal of the ninth transistor and the first terminal of the tenth transistor and between the second terminal of the thirteenth transistor and the first terminal of the fourteenth transistor, and the second terminal of the second charge-discharge circuit is electrically connected between the second terminal of the eleventh transistor and the first terminal of the twelfth transistor and between the second terminal of the fifteenth transistor and the first terminal of the sixteenth transistor.

20. The electronic device according to claim 18, wherein the inductive charge transfer circuit comprises a seventeenth transistor, an eighteenth transistor, and an inductor, the first charge-discharge circuit comprises a third capacitor, and the second charge-discharge circuit comprises a fourth capacitor, wherein,
a first terminal of the seventeenth transistor is electrically connected to a second terminal of the third capacitor, a drive terminal of the seventeenth transistor is electrically connected to the transistor control circuit via a transistor driver, and a second terminal of the seventeenth transistor is electrically connected to a first terminal of the inductor, a second terminal of the inductor is electrically connected to a second terminal of the eighteenth transistor, a drive terminal of the eighteenth transistor is electrically connected to the transistor control circuit via a transistor driver, and a first terminal of the eighteenth transistor is electrically connected to a second terminal of the fourth capacitor.
